(19) United States
(12) Patent Application Publication
(10) Pub. No.: US 2005/0029410 A1
(43) Pub. Date: Feb. 10, 2005

(54) Anchor device for holding hoses

(76) Inventor: David Eugene Walker, Tucson, AZ (US)

Correspondence Address: Obermayer, Rebmann, Maxwell & Hippel, LLP, One Penn Center - 19th Floor, 1617 John F. Kennedy Blvd., Philadelphia, PA, 19103-1895, US

(21) Appl. No.: 10/635,236

(22) Filed: Aug. 6, 2003

(51) Int. Cl. B05B 15/06

(52) U.S. Cl. 248/80; 248/910

(57) ABSTRACT

An anchor device for holding hoses against retracting slidable movement comprising: a base member comprising a weighted anchor to be positioned approximate to a length of hose and a flexible strap affixed on one end to the base member and having a length configured to wrap around the hose so as to support the hose in a rigid position relative to the base member; and means for affixing the hose in a locked position.

### FIELD OF THE INVENTION

The present invention is directed to the field of support mechanisms. In particular, the present invention is directed to the field of support mechanism for maintaining the position of hoses and hosing such as those used by truck mounted cleaning equipment.

### BACKGROUND OF THE INVENTION

This invention relates to a new and novel anchoring system for holding hoses against retracting slidable movement. Truck mounted cleaning equipment frequently use long hoses to reach from a vehicle to various rooms in a dwelling or commercial building. Such hoses are frequently used by carpet cleaning services. Such hoses may often be over 80 feet in length and are often pulled up multiple steps of stairways in order to reach rooms in a multiple story dwelling. In such a case, a rather heavy retracting or gravitational pull exists on the hoses making it difficult for the operator to handle the cleaning head in upper floors.

To date there have been few attempts to resolve this problem. U.S. Pat. No. 4,799,641 to Koraskow, issued in 1989, describes a device for holding hoses against such retracting slidable movement. The Koraskow patent shows as a flat base member which is arranged to sit on a carpeted floor and has a top clamp plate arranged to releasably clamp various hoses. The base member has one or more prongs pivotally supporting thereon and arranged to slide freely over the carpet.

The fundamental problem with this system is that it has a number of moving parts and cannot be rapidly adjusted. Specifically the device has clamps which must be physically attached and removed. For this reason, the system is cumbersome and difficult to maneuver.

It would be desirable to provide a system which relieves the operator from pulling forces existing on a machine hose but which can be more easily maneuvered.

It would be specifically more desirable to provide a system in which the machine tool hoses are more easily anchored and more easily adjusted by means of an easy to place and remove attachment strap. Such a strap could easily be placed upon a hose, and quickly tightened, adjusted and/or removed.

These and other objects of the present invention will become apparent from the detailed description that follows.

### SUMMARY OF THE INVENTION

In accordance an anchor for holding a hose of the type used by commercial cleaning services comprising: a base member comprising a weighted anchor anchor which is placed at a point along a length of hose affixed; and a strap affixed to the weight for wrapping around said hose and preventing said hose from retracting slidably relative to the weight. The anchor device may further comprise clamp means for securing the strap to the hose. In a further embodiment the clamp means comprises a velcro attaching means.

In a further embodiment, the invention is an anchor device for holding hoses against retracting slidable movement comprising: a base member comprising a weighted anchor to be positioned relative a length of hose; a strap affixed on one end to the base member and having a length configured to wrap around the hose so as to support the hose in a rigid position relative to the base member; and means for affixing the hose in a locked position.

### BRIEF DESCRIPTION OF THE FIGURES

FIG. 1 is a perspective view of the hose anchor of the present invention.

FIG. 2 is a perspective view of the hose anchor of the present invention as shown on a stairway.

### DETAILED DESCRIPTION OF THE PREFERRED EMBODIMENT

The present device is particularly useful as described in conjunction with an anchoring mechanism for cleaning hoses such as those used by commercial and residential carpet cleaners against retracting slidable movement. It is specifically desired that the hoses be anchored against rearward retractable sliding movement.

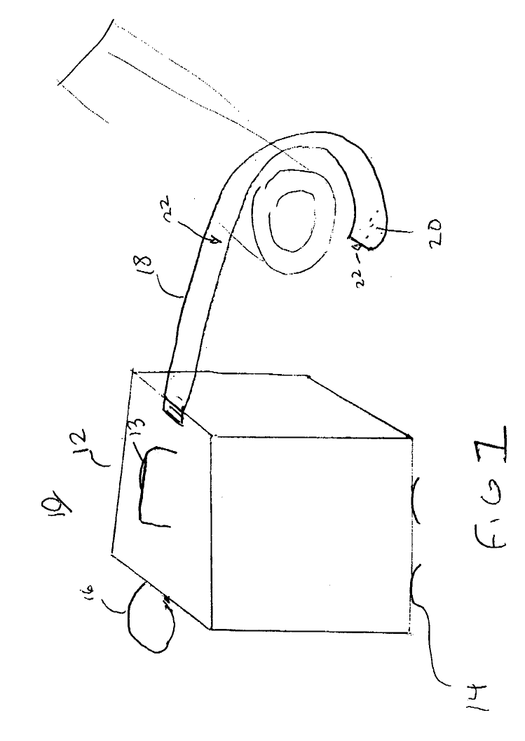

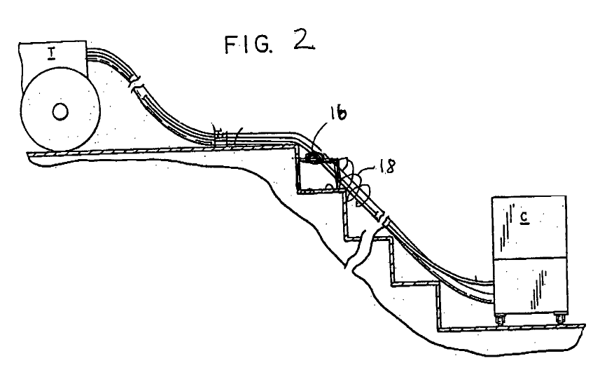

Referring to FIG. 1, the present invention is shown and described. In a most preferred embodiment, the invention comprises a support weight 10 which holds the hose 15 in position. The weight comprises an anchor 12 and may have a weight of between 25 and 30 pounds. The anchor 12 may have suction cups 14 on its bottom to retain its position on a wooden or tile floor. The anchor 12 may also have an attachment mechanism 16 to secure it to a banister on a stairway as shown in FIG. 2.

The anchor 12, has attached there to a flexible strap 18. In one embodiment, the strap may comprise a flexible material such as nylon with a rubber or treaded surface. The strap 18 is wrapped around the hose and is used to maintain it in position. The strap may have a clip or a velcro fastener 20. In either situation, the strap and weight support the lateral position of the hose and prevent it from retracting backward.

In operation the anchor is placed in position relative to the hose to be anchored. The strap is placed around the hose, where friction maintains the position of the hose relative to anchor. The device can include a velcro or mechanical fastener or clip 22.

The present invention has been described with reference to the above described preferred embodiment. It is to be appreciated that other embodiments fulfill the spirit and scope of the present invention and that the true nature and scope of the present invention will be determined with reference to the claims attached hereto.

1. An anchor for holding a hose of the type used by commercial cleaning services comprising:
a base member comprising a weighted anchor which is placed at a point along a length of hose which is to be retained; and
a flexible strap affixed to the weight for wrapping around said hose and preventing said hose from retracting slidably relative to the anchor.

2. The anchor device of claim 1 further comprising clamp means for securing the strap to the hose.

3. The anchor device of claim 2 wherein the clamp means comprises a velcro attaching means.

4. An anchor device for holding hoses against retracting slidable movement comprising:
a base member comprising a weighted anchor to be positioned proximate to a length of hose.
strap affixed on one end to the base member and having a length configured to wrap around the hose so as to support the hose in a rigid position relative to the base member; and
means for affixing the strap in a locked position.

5. An anchor device for holding a hose against retracting slidable movement comprising:
a base member comprising a weighted anchor to be positioned approximate to a length of hose.
strap affixed on one end to the base member and having a length configured to wrap around the hose so as to support the hose in a rigid position relative to the base member;
means for affixing the strap in a locked position; and
means for securing the anchor.
